(19) United States
(12) Patent Application Publication
(10) Pub. No.: US 2026/0300404 A1
(43) Pub. Date: Oct. 1, 2026

(54) DATA ANALYSIS METHOD, APPARATUS, ELECTRONIC DEVICE, STORAGE MEDIUM, AND PROGRAM PRODUCT

(71) Applicant: Beijing Youzhuju Network Technology Co., Ltd., Beijing (CN)

(72) Inventors: Jianhui LI, Beijing (CN); Mengni LIU, Beijing (CN); Jinya WU, Beijing (CN); Haibo WU, Beijing (CN); Jun YAO, Beijing (CN); Jia XU, Beijing (CN); Wenjian DUAN, Beijing (CN); Kexin ZHANG, Beijing (CN); Hui SHI, Beijing (CN)

(21) Appl. No.: 19/635,510

(22) Filed: Mar. 31, 2026

(30) Foreign Application Priority Data
Apr. 1, 2025 (CN) 202510405945.X

(51) Int. Cl. G06F 16/9038

(52) U.S. Cl. CPC G06F 16/9038

(57) ABSTRACT

Provided are a data analysis method and apparatus, an electronic device, a storage medium and a program product, which relate to the technical field of data analysis. The method includes: determining a target analysis condition and a first analysis object in response to an interaction operation for an analysis condition area in a first analysis page; acquiring first search information which satisfies the target analysis condition and which is related to the first analysis object, where the first search information includes a first search source, a first search route and a first search result; analyzing the first search information on the basis of traffic analysis information of search information in the first search information, to obtain a first analysis result; and displaying the first analysis result in the first analysis page, and respectively displaying analysis nodes corresponding to the first search source, the first search route and the first search result, and a link relationship between the analysis nodes, where corresponding traffic analysis information is displayed in corresponding areas of the analysis nodes. By means of the present disclosure, the problem of search analysis results being relatively sparse may be solved.

### CROSS-REFERENCE TO RELATED APPLICATIONS

The present application is based on and claims priority of CN Application No. 202510405945.X, filed on Apr. 1, 2025, the disclosure of which is incorporated herein by reference in its entirety.

### TECHNICAL FIELD

The present disclosure relates to the technical field of data analysis, and in particular, to a data analysis method and apparatus, an electronic device, a storage medium, and a program product.

### BACKGROUND

With the development of self-media technologies, an increasing number of users search for products through self-media platforms, such as short video platforms.

### SUMMARY

The present disclosure provides a data analysis method and apparatus, an electronic device, a storage medium, and a program product.

In a first aspect, the present disclosure provides a data analysis method. The method includes:
determining a target analysis condition and a first analysis object in response to an interaction operation for an analysis condition area in a first analysis page;
acquiring first search information satisfying the target analysis condition and traffic analysis information of search information in the first search information, the first search information being related to the first analysis object, and the first search information including a first search source, a first search route, and a first search result;
analyzing the first search information based on the traffic analysis information to obtain a first analysis result;
displaying the first analysis result in a first display area of the first analysis page; and
respectively displaying, in a second display area of the first analysis page, analysis nodes corresponding to the first search source, the first search route, and the first search result, and displaying a link relationship between the analysis nodes, the link relationship being used to represent a search path among the first search source, the first search route, and the first search result, and traffic analysis information of corresponding search information being displayed in corresponding areas of the analysis nodes.

In a second aspect, the present disclosure provides a data analysis apparatus. The apparatus includes:
a first interaction module configured to determine a target analysis condition and a first analysis object in response to an interaction operation for an analysis condition area in a first analysis page;
a first acquisition module configured to acquire first search information satisfying the target analysis condition and traffic analysis information of search information in the first search information, the first search information being related to the first analysis object, and the first search information including a first search source, a first search route, and a first search result;
a first processing module configured to analyze the first search information based on the traffic analysis information to obtain a first analysis result;
a first display module configured to display the first analysis result in a first display area of the first analysis page; and
a second display module configured to respectively display, in a second display area of the first analysis page, analysis nodes corresponding to the first search source, the first search route, and the first search result, and display a link relationship between the analysis nodes, the link relationship being used to represent a search path among the first search source, the first search route, and the first search result, and traffic analysis information of corresponding search information being displayed in corresponding areas of the analysis nodes.

In a third aspect, the present disclosure provides an electronic device. The electronic device includes a memory and a processor, the memory and the processor are communicatively connected to each other, the memory stores computer instructions, and the processor executes the computer instructions to perform the data analysis method according to the first aspect or any corresponding implementation thereof.

In a fourth aspect, the present disclosure provides a computer-readable storage medium storing computer instructions, the computer instructions being used to cause a computer to perform the data analysis method according to the first aspect or any corresponding implementation thereof.

In a fifth aspect, the present disclosure provides a computer program product including computer instructions, the computer instructions being used to cause a computer to perform the data analysis method according to the first aspect or any corresponding implementation thereof.

### BRIEF DESCRIPTION OF THE DRAWINGS

In order to more clearly illustrate the technical solutions in the specific embodiments of the present disclosure or in the prior art, the following will briefly introduce the drawings that need to be used in the description of the specific embodiments or the prior art. Obviously, the drawings in the following description are some embodiments of the present disclosure. For those of ordinary skill in the art, other drawings may be obtained based on these drawings without creative efforts.

FIG. 1 is a schematic diagram of an application scenario according to an embodiment of the present invention;

FIG. 2 is a schematic flowchart of a data analysis method according to an embodiment of the present disclosure;

FIG. 3 is a schematic diagram of a search process according to an embodiment of the present disclosure;

FIG. 4 is a schematic diagram of a first type of first analysis page according to an embodiment of the present disclosure;

FIG. 5 is a schematic diagram of a second type of first analysis page according to an embodiment of the present disclosure;

FIG. 6 is a schematic diagram of a first type of second display area according to an embodiment of the present disclosure;

FIG. 7 is a schematic diagram of a second type of second display area according to an embodiment of the present disclosure;

FIG. 8 is a schematic diagram of a third type of second display area according to an embodiment of the present disclosure;

FIG. 9 is a schematic diagram of a fourth type of second display area according to an embodiment of the present disclosure;

FIG. 10 is a schematic diagram of a second analysis page according to an embodiment of the present disclosure;

FIG. 11 is a schematic diagram of a third analysis page according to an embodiment of the present disclosure;

FIG. 12 is a schematic diagram of a first type of third display area according to an embodiment of the present disclosure;

FIG. 13 is a schematic diagram of a second type of third display area according to an embodiment of the present disclosure;

FIG. 14 is a schematic diagram of a third type of third display area according to an embodiment of the present disclosure;

FIG. 15 is a schematic diagram of a third type of first analysis page according to an embodiment of the present disclosure;

FIG. 16 is a structural block diagram of a data analysis apparatus according to an embodiment of the present disclosure; and

FIG. 17 is a structural block diagram of an electronic device according to an embodiment of the present disclosure.

### DETAILED DESCRIPTION OF EMBODIMENTS

In order to make the purpose, technical solutions and advantages of the embodiments of the present disclosure clearer, the technical solutions in the embodiments of the present disclosure will be clearly and completely described below in conjunction with the drawings in the embodiments of the present disclosure. Obviously, the described embodiments are part of the embodiments of the present disclosure, but not all of them. Based on the embodiments in the present disclosure, all other embodiments obtained by those skilled in the art without creative efforts belong to the protection scope of the present disclosure.

It should be understood that before using the technical solutions disclosed in the embodiments of the present disclosure, the user should be informed of the type, range of use, use scenarios, etc. of the personal information involved in the present disclosure and obtain the authorization of the user in an appropriate manner in accordance with relevant laws and regulations.

For example, in response to receiving an active request from a user, prompt information is sent to the user to clearly prompt the user that the requested operation will require access to and use of the user's personal information. In this way, the user may independently choose whether to provide personal information to software or hardware such as an electronic device, an application, a server or a storage medium that perform operations of the technical solutions of the present disclosure based on the prompt information.

As an optional but non-limiting implementation, in response to receiving an active request from a user, the manner of sending prompt information to the user may be, for example, a pop-up window, and the prompt information may be presented in the pop-up window in text. In addition, the pop-up window may also carry a selection control for the user to select “agree” or “disagree” to provide personal information to the electronic device.

It should be understood that the above process of notifying and obtaining user authorization is only illustrative and does not limit the implementation of the present disclosure, and other methods that meet relevant laws and regulations may also be applied to the implementation of the present disclosure.

It should be understood that the data involved in this technical solution (including but not limited to the data itself, acquisition or use of the data) should comply with requirements of corresponding laws, regulations and related provisions.

With the development of self-media technologies, an increasing number of users search for products through media applications, such as short video applications. Therefore, an increasing number of brand owners expect to know the search situation of the brand owners or their products. However, data analysis platforms in related technologies mainly analyze the search situation of the brand owners or the products through popular search terms, and search analysis results are relatively thin. At present, brand owners and the like mainly analyze the search conditions of the brand owners or the products through popular search terms, resulting in relatively thin search analysis results.

According to the data analysis method provided in the embodiments of the present disclosure, on the one hand, the first search information is analyzed based on the traffic analysis information corresponding to the search information in the first search information to obtain and display the first analysis result. Therefore, the key information in the first search information may be quickly learned through the first analysis result, so as to analyze the overall search condition of the first analysis object. On the other hand, the analysis nodes corresponding to the first search source, the first search route, and the first search result are displayed, and the link relationship between the analysis nodes is displayed. Therefore, the search path for the first analysis object may be restored, so as to analyze the main search source of the first analysis object in combination with the traffic analysis information of the first search source. Moreover, the main search route of the first analysis object is analyzed in combination with the traffic analysis information of the first search route. Moreover, the main undertaking result of the first analysis object is analyzed in combination with the traffic analysis information of the first search result. Furthermore, the search condition of the first analysis object is analyzed in multiple dimensions according to the first analysis result, the link condition displayed in the second display area, and the traffic analysis information, so as to solve the problem of relatively thin search analysis results.

The beneficial effects of the data analysis apparatus, the electronic device, the storage medium, and the program product correspond to the beneficial effects of the data analysis method, and details are not described herein again.

As an optional application scenario of the embodiments of the present invention, as shown in FIG. 1 which is an optional schematic diagram of an application scenario according to an embodiment of the present disclosure, a client 1 and a server 2 are included in an overall data analysis scenario. The server 2 accesses multiple media applications, and the server 2 is configured to collect and analyze operation data, search data, etc. generated in the media applications to provide data required for subsequent data analysis. An analysis condition and an analysis object are determined in the client 1, required data is queried from the server 2 according to the analysis condition and the analysis object, the queried data is processed accordingly, and then the processed data is displayed on the client 1.

In view of this, according to an embodiment of the present disclosure, an embodiment of a data analysis method is provided. It should be noted that the steps shown in the flowchart of the drawings may be executed in a computer system such as a set of computer executable instructions, and although a logical order is shown in the flowchart, in some cases, the steps shown or described may be executed in an order different from that here.

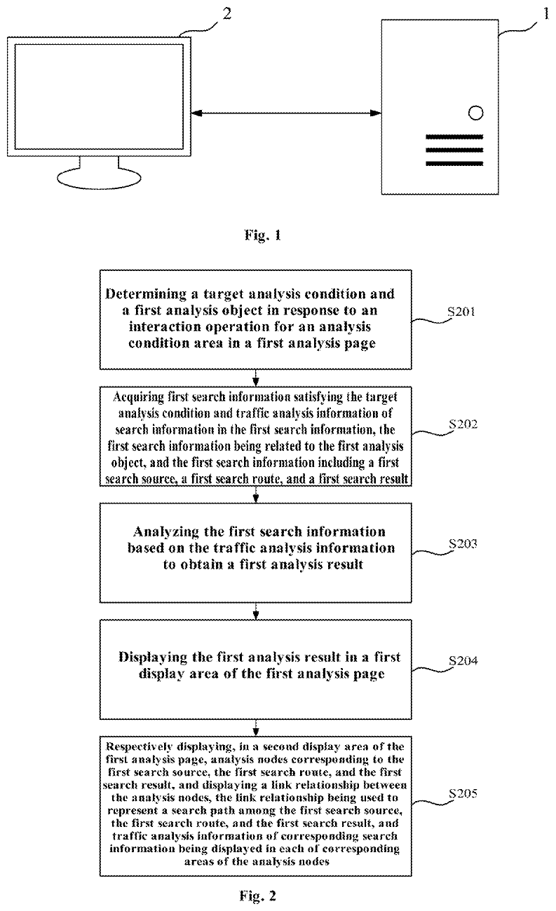

In this embodiment, a data analysis method is provided, which may be used for a data analysis platform, such as a client of the data analysis platform. FIG. 2 is a schematic flowchart of a data analysis method according to an embodiment of the present disclosure. As shown in FIG. 2, the process includes the following steps.

Step S201: determining a target analysis condition and a first analysis object in response to an interaction operation for an analysis condition area in a first analysis page.

In practical applications, a user may log in to a client of a data analysis platform with an account, configure a target object to be analyzed subsequently, such as a brand owner and a product, on the client, and configure object information of the target object, such as an industry to which the target object belongs, a brand word, and a comparison object (such as a brand owner or a product for comparison).

At least one analysis condition configuration control is provided in the analysis condition area, and the analysis condition includes at least one of an industry, a time range, and a search term, which may be adjusted according to an actual situation. The target analysis condition is configured through an interaction operation with the configuration control, for example, “beauty industry” and “from 2025-01-01 to 2025-01-03”.

Optionally, the target analysis condition includes at least one of a target industry, a target time range, and a target search term. In addition, other analysis conditions may be configured as the target analysis condition according to the actual situation, which is not limited here.

In response that the analysis condition includes a search term, one or more search terms may be further configured to obtain a search term set, and the target analysis condition is selected and determined through the search term set subsequently. For example, the search term set includes search term 1, search term 2, etc., and the user may select and configure the target analysis condition through the search term set, for example, the target analysis condition includes search term 1. In addition, the search term set may further include multiple sub-sets, each sub-set includes multiple search terms, and the user may select a batch of search terms as analysis conditions in batches through selection of the sub-sets to obtain the target analysis condition.

Specifically, before the target analysis condition is determined, during a configuration process of the target analysis condition, or after the target analysis condition is determined, the target object may be automatically determined according to login information of the client, and the target object is used as the first analysis object. Alternatively, an analysis object configuration control is displayed in the analysis condition area, and the first analysis object is determined through an interaction operation with the configuration control. Alternatively, a default analysis object is set, and the default analysis object is used as the first analysis object. A manner of determining the first analysis object is not limited here.

Step S202: acquiring first search information satisfying the target analysis condition and traffic analysis information of search information in the first search information, the first search information being related to the first analysis object, and the first search information including a first search source, a first search route, and a first search result.

Optionally, the client generates a data request based on the target analysis condition and the first analysis object, and sends the data request to a server, and the server queries, in search information of the first analysis object, the first search information satisfying the target analysis condition. Alternatively, the client communicates with a media application to acquire the first search information from the media application. A manner of acquiring the first search information is not limited here.

Optionally, the client may acquire the traffic analysis information of the search information in the first search information from the server or the media application. The search information in the first search information is the first search source, the first search route, and the first search result.

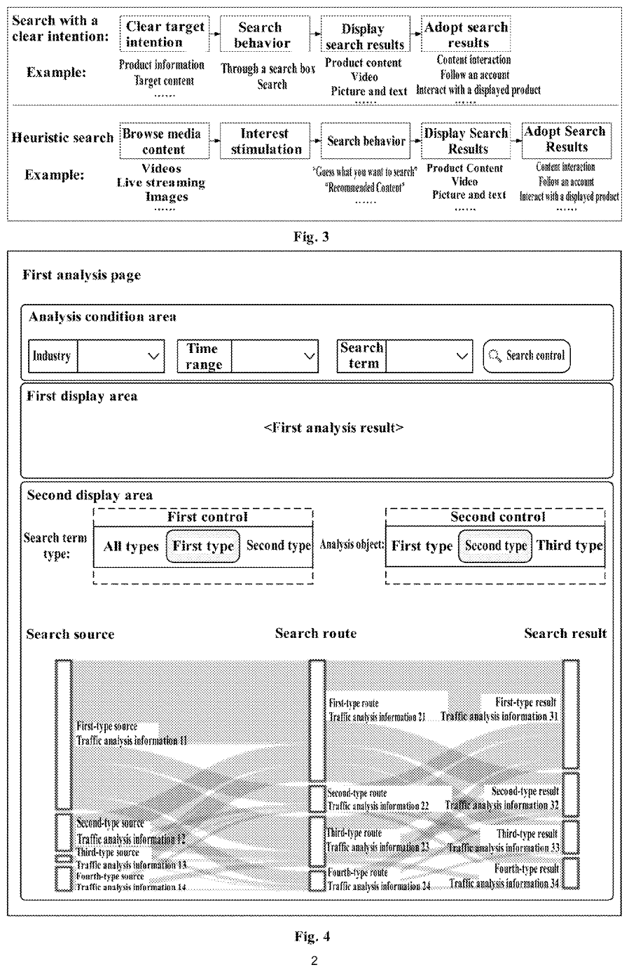

Optionally, the first search source represents a search source type (also referred to as a pre-search content type) of the first analysis object. As shown in FIG. 3, in an actual search scenario, there are mainly two types of searches, one is a search with a clear intention (i.e., a direct search), and the other is a heuristic search (i.e., a search after displaying media content). The search with the clear intention has a clear target intention, for example, product information, target content, etc. to be searched for. Then, a search behavior is generated according to the target intention, mainly through a search box. Then, search results are displayed, such as product content, a video, a picture and text, etc. In response that the user adopts the search results, content interaction, account following, interaction with the displayed product, etc. are generated.

Most heuristic searches are to browse media content such as a video, a picture and text, etc., and then stimulate a search interest, thereby generating a search behavior. For example, the search is performed through “guess what you want to search”, “recommended search terms”, etc. displayed in the media content, and search results such as product content, a video, a picture and text, etc. are displayed. In response that the user adopts the search results, content interaction, account following, interaction with the displayed product, etc. are generated.

It may be learned based on the above two types of searches that the first search source includes at least one of a direct search, a search after displaying media content, and other content, and the search after displaying media content may be further divided into a search after displaying media content recommended by a third party (i.e., an object other than the target object) and a search after displaying associated content (such as a homepage of the target object, etc.) of the target object.

Optionally, the first search route includes a first search point and a first search channel. The first search point includes at least one of a search association word, a search box, a tabulator key (Tab key) search, a historical search term, a comment area ceiling word, a search box gray word, a comment area entity word, a recommended search term (such as a guess what you want to search term), a topic word, and a keyword (also referred to as a bottom bar word) located in a bottom navigation bar or a related search area, and may further include other search-related points, which is not limited here. The first search channel includes at least one type of search channel, for example, a comprehensive search channel, a mall search channel, a product vertical search channel, a video vertical search channel, a user vertical search channel, and other channels.

Optionally, the first search result represents a content genre exposed after the first analysis object is searched for. The first search result includes at least one of a video, a product, a picture and text, and other results, and the video may be further divided into a short video and a live video.

In practical applications, search information on the media application, browsing information of media content (such as a video, a picture, a comment, etc.), interaction information of the media content, etc. may be recorded through event tracking, etc., and the media application or the server determines a search path of the first analysis object on the media application based on this information, to analyze and obtain the first search information, and further analyze and obtain the traffic analysis information of the search information in the first search information.

Optionally, the traffic analysis information includes a traffic proportion of each piece of information in corresponding search information.

Specifically, the traffic analysis information of the first search source includes a traffic proportion of each search source in all search sources. The traffic analysis information of the first search route includes a traffic proportion of each search route in all search routes. The traffic analysis information of the first search result includes a traffic proportion of each search result in all search results.

Further, the traffic analysis information of the first search route includes traffic analysis information of the first search point and traffic analysis information of the first search channel. The traffic analysis information of the first search point includes a traffic proportion of each search point in all search points. The traffic analysis information of the first search channel includes a traffic proportion of each search channel in all search channels.

Step S203: analyzing the first search information based on the traffic analysis information to obtain a first analysis result.

Optionally, a first analysis template corresponding to the traffic analysis information may be pre-configured, and the first search information is interpreted through the first analysis template to obtain the first analysis result. Alternatively, the first search information and the traffic analysis information are input into a pre-trained language model for analysis to obtain the first analysis result. An analysis manner of the first search information is not limited here, and may be selected according to an actual situation.

Optionally, the first analysis result includes a service optimization suggestion for the first search information.

Step S204: displaying the first analysis result in a first display area of the first analysis page.

For aesthetics of the page and readability of data, the first display area may be divided in the first analysis page to display the first analysis result. A position and a size of the first display area may be set according to the actual situation, which is not limited here.

Step S205: respectively displaying, in a second display area of the first analysis page, analysis nodes corresponding to the first search source, the first search route, and the first search result, and displaying a link relationship between the analysis nodes, the link relationship being used to represent a search path among the first search source, the first search route, and the first search result, and traffic analysis information of corresponding search information being displayed in corresponding areas of the analysis nodes.

In practical applications, the analysis node of the first search source, the analysis node of the first search route, and the analysis node of the first search result may be sequentially displayed according to an operation sequence among the first search source, the first search route, and the first search result. For example, as shown in FIG. 4, the analysis node of the first search source, the analysis node of the first search route, and the analysis node of the first search result are displayed from left to right in sequence.

Optionally, a length of the analysis node is related to the traffic analysis information of the corresponding search information. For example, as shown in FIG. 4, the first search source includes a first-type source, a second-type source, a third-type source, and a fourth-type source, and the traffic analysis information of the first-type source represents that a traffic proportion of the first-type source in the first search source is the highest, then the analysis node of the first-type source is the longest.

Optionally, a link width is related to the traffic analysis information of the corresponding search information. For example, as shown in FIG. 4, the first search route includes a first-type route, a second-type route, a third-type route, and a fourth-type route, and the traffic analysis information of the first-type source and the first-type route represents that a traffic proportion from the first-type source to the first-type route is the highest in traffic guidance of the first-type source, then the link width between the first-type source and the first-type route is greater than the link width between the first-type source and other routes.

Optionally, the traffic analysis information is displayed on one side of the corresponding analysis node.

Further, traffic analysis information of the same type of search information is displayed on the same side of the analysis node. For example, as shown in FIG. 4, traffic analysis information 11 of the first-type source, traffic analysis information 12 of the second-type source, traffic analysis information 13 of the third-type source, and traffic analysis information 14 of the fourth-type source are all displayed on the right side of the analysis node. For another example, as shown in FIG. 4, traffic analysis information 31 of a first-type result, traffic analysis information 32 of a second-type result, traffic analysis information 33 of a third-type result, and traffic analysis information 34 of a fourth-type result in the first search result are all displayed on the left side of the analysis node.

According to the data analysis method provided in this embodiment, on the one hand, the first search information is analyzed based on the traffic analysis information corresponding to the search information in the first search information to obtain and display the first analysis result. Therefore, the key information in the first search information may be quickly learned through the first analysis result, so as to analyze the overall search condition of the first analysis object. On the other hand, the analysis nodes corresponding to the first search source, the first search route, and the first search result are displayed, and the link relationship between the analysis nodes is displayed. Therefore, the search path for the first analysis object may be restored, so as to analyze the main search source of the first analysis object in combination with the traffic analysis information of the first search source. Moreover, the main search route of the first analysis object is analyzed in combination with the traffic analysis information of the first search route. Moreover, the main undertaking result of the first analysis object is analyzed in combination with the traffic analysis information of the first search result. Furthermore, the search condition of the first analysis object is analyzed in multiple dimensions according to the first analysis result, the link condition displayed in the second display area, and the traffic analysis information, so as to improve the accuracy of search analysis.

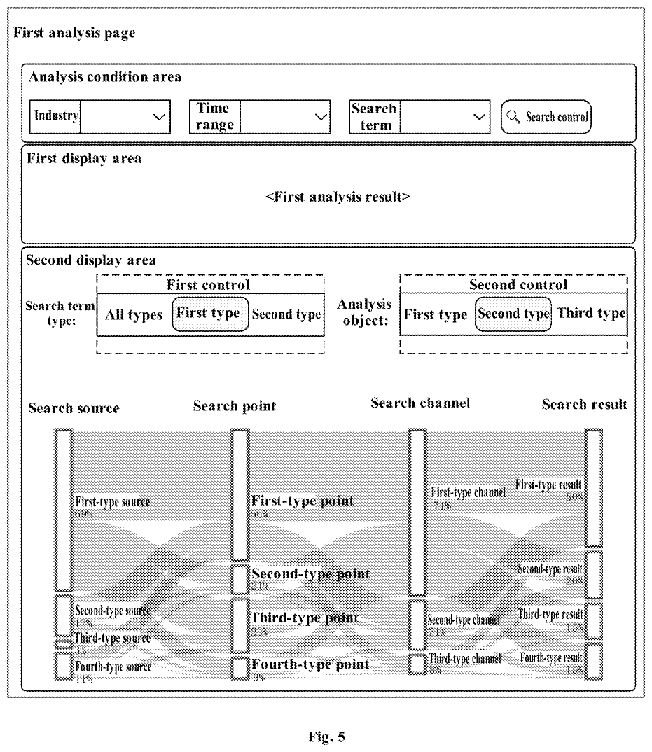

As an example, as shown in FIG. 5, the user may configure an industry, a time range, a search term, etc. through the analysis condition area to determine the target analysis condition. The first analysis object is determined in combination with the target object preset by the user. Then, the analysis nodes corresponding to the first search source, the first search point, the first search channel, and the first search result are respectively displayed in the second display area, and the traffic analysis information of the corresponding search information is displayed in the corresponding area of the analysis node, for example, a traffic proportion of the first-type source (such as a direct search) is 69%, a traffic proportion of a second-type source (a search after displaying media content) is 17%, a traffic proportion of a first-type point (such as a search association word) is 56%, and a traffic proportion of a third-type point (such as a comment area ceiling word) is 23%, etc. Meanwhile, the first analysis result is displayed in the first display area, and the first analysis result corresponds to the content in the second display area. For example, the first analysis result is that “the traffic proportion of the direct search is 69%, and the search is mainly performed through the search association word (56%) and the comment area ceiling word (23%). The search rate of the brand may be improved through promotion of recommended content for the brand. The traffic proportion of the search after displaying the media content is 17%, where the traffic proportion of the search after displaying the media content recommended by the third party is 3%, and the search traffic may be improved through a recommendation channel in cooperation with comment maintenance”.

In some optional implementations, the data analysis method of the present disclosure further includes: hiding, in the first display area of the first analysis page, a link relationship not connected to a first analysis node in response to an interaction operation with the first analysis node in the first analysis page.

It should be noted that the first analysis node is an analysis node selected in the second display area.

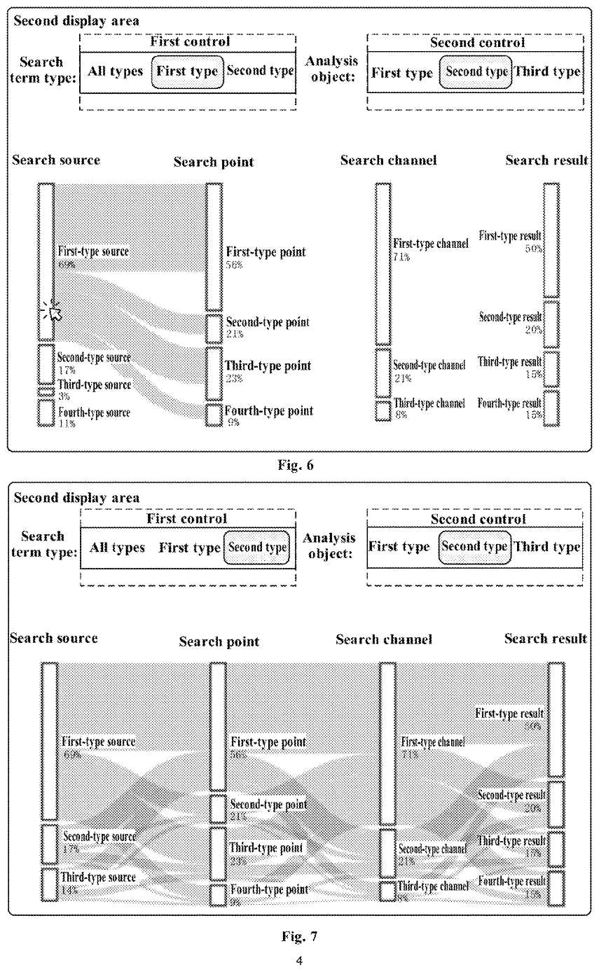

It may be understood that in response that the user clicks on the first analysis node, the link relationship irrelevant to the first analysis node is hidden. For example, as shown in FIG. 6, in response that there is interaction with the analysis node of the first-type source, only the link relationship between the first-type source and the first search point is displayed, and other link relationships are hidden.

According to the data analysis method provided in this embodiment, the link relationship not connected to the first analysis node is hidden when interacting with the first analysis node in the first analysis page. Therefore, the link relationship/search path of the node of interest may be specifically analyzed, and interference of remaining link relationships may be avoided.

In some optional implementations, a first control is further displayed in the first analysis page, and the first control is used to switch a search term type. The data analysis method of the present disclosure further includes:

Step a1: determining a target search term type in response to an interaction operation with the first control.

The target search term type is one of all types, a search term type (such as a brand word) corresponding to the target object, and a search term type (such as a non-brand word) irrelevant to the target object. For example, as shown in FIG. 7, in response that a second type is selected through the first control, the search term type is switched from a first type (such as a brand word) as shown in FIG. 5 to the second type (such as a non-brand word), and the target search term type is the second type.

Step a2: acquiring second search information corresponding to the target search term type, the second search information being related to the first analysis object and satisfying the target analysis condition, and the second search information including a second search source, a second search route, and a second search result.

It should be noted that for the related description of the second search information, reference may be made to the related description of the first search information, which will not be repeated here.

Step a3: updating, based on the second search information, the analysis nodes displayed in the first analysis page, the link relationship between the analysis nodes, and the traffic analysis information.

Exemplarily, referring to FIG. 5 and FIG. 7, when the search term type is switched from the first type to the second type, in response that the second search source changes compared with the first search source, the analysis node of the first search source is updated according to the second search source, and the link relationship between the analysis nodes and the traffic analysis information displayed in the corresponding area of the analysis node are updated according to the traffic analysis information of the second search source.

According to the data analysis method provided in this embodiment, the first control for switching the search term type is provided. Therefore, the search condition of the first analysis object may be analyzed from the dimension of different search term types.

In some optional implementations, a second control is further displayed in the first analysis page, and the second control is used to switch the analysis object. The data analysis method of the present disclosure further includes:

Step b1: determining a second analysis object in response to an interaction operation with the second control.

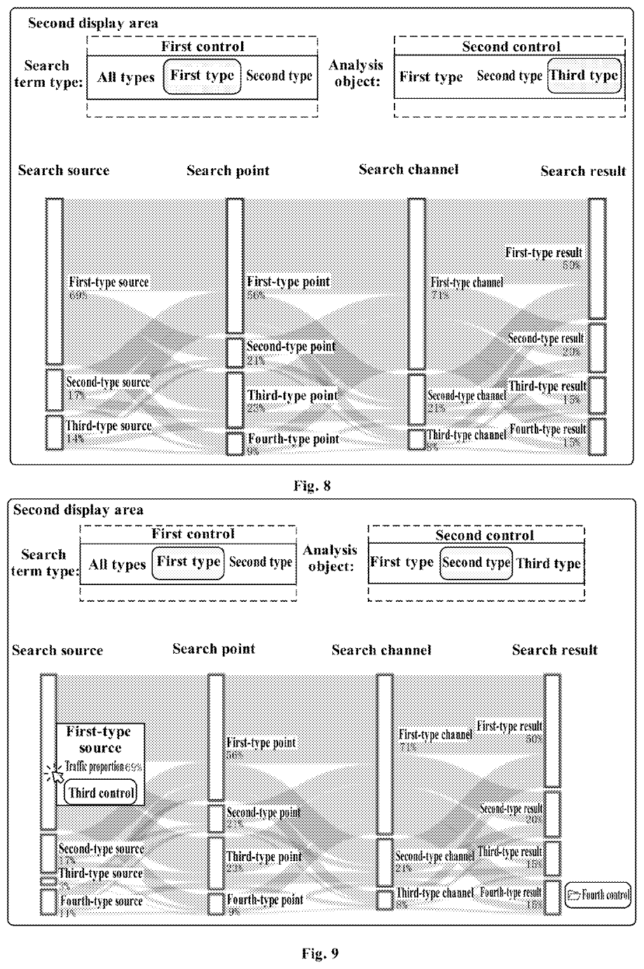

The second analysis object is one of the target object, a comparison object (such as a comparison brand) of the target object, and other objects in the industry to which the target object belongs (such as objects ranked top 20 in the industry to which the target object belongs in terms of search). For example, as shown in FIG. 8, in response that a third type (such as objects ranked top 20 in the industry to which the target object belongs in terms of search) is selected through the second control, the search term type is switched from the second type (such as a comparison brand) as shown in FIG. 5 to the third type, and the second analysis object is the third type.

Step b2: acquiring third search information of the second analysis object, the third search information satisfying the target analysis condition, and the third search information including a third search source, a third search route, and a third search result.

It should be noted that for the related description of the third search information, reference may be made to the related description of the first search information, which will not be repeated here.

Step b3: updating, based on the third search information, the analysis nodes displayed in the first analysis page, the link relationship between the analysis nodes, and the traffic analysis information.

Exemplarily, referring to FIG. 5 and FIG. 6, when the analysis object is switched from the first analysis object to the second analysis object, in response that the third search source changes compared with the first search source, the analysis node of the first search source is updated according to the third search source, and the link relationship of the analysis nodes and the traffic analysis information displayed in the corresponding area of the analysis node are updated according to the traffic analysis information of the third search source.

According to the data analysis method provided in this embodiment, the second control for switching the analysis object is provided. Therefore, the search data analysis may be performed from the dimension of different analysis objects.

In some optional implementations, the data analysis method of the present disclosure further includes:

Step c1: displaying a third control corresponding to a second analysis node in response to an interaction operation with the second analysis node in the first analysis page, the third control being used to add associated object information of the first analysis object.

The second analysis node is an analysis node selected in the second display area.

Optionally, the associated object information includes information of an associated object of the first analysis object. The associated object includes an object that searches for the first analysis object and/or searches for associated content (such as a product of the first analysis object) of the first analysis object.

Specifically, in response to the interaction operation with the second analysis node in the first analysis page, a sub-page corresponding to the second analysis node is displayed, and the third control is displayed in the sub-page. The third control is used to add the associated object information corresponding to the second analysis node to the associated object information of the first analysis object.

Step c2: adding, in response to an interaction operation with the third control, object information of an associated object generated by triggering search information corresponding to the second analysis node to the associated object information of the first analysis object.

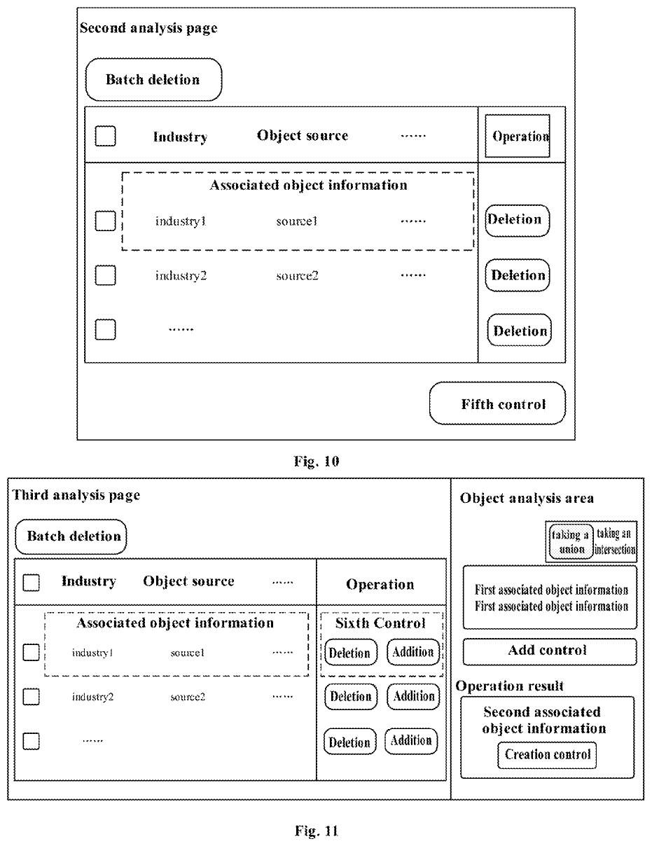

Exemplarily, as shown in FIG. 9, in response that the second analysis node is an analysis node of the first-type source (such as a direct search), and both associated object 1 and associated object 2 search for the first analysis object through the direct search, the associated objects generated by triggering the search information corresponding to the second analysis node include associated object 1 and associated object 2, and the object information of associated object 1 and associated object 2 may be added to the associated object information of the first analysis object through the interaction operation with the third control.

According to the data analysis method provided in this embodiment, the third control for adding the associated object information of the first analysis object is provided when interacting with the second analysis node. Therefore, the associated object of the first analysis object may be added according to analysis requirements to analyze the feature of the associated object that searches for the first analysis object.

In some optional implementations, a fourth control is further displayed in the first analysis page, and the fourth control is used to trigger display of at least one piece of associated object information of the first analysis object.

Exemplarily, as shown in FIG. 9, the fourth control is further displayed in the second display area of the first analysis page, and the user may click on the fourth control to trigger the display of the associated object information of the first analysis object.

Further, the number of pieces of associated object information of the first analysis object is further displayed in a corresponding area of the fourth control.

According to the data analysis method provided in this embodiment, the third control for triggering the display of the associated object information is provided. Therefore, it is convenient to analyze the feature of the associated object of the first analysis object to comprehensively analyze the search condition of the first analysis object.

In some optional implementations, the data analysis method of the present disclosure further includes:

Step d1: displaying, in a second analysis page, at least one piece of associated object information and a fifth control in response to an interaction operation with the fourth control, the fifth control being used to create associated object information of the first analysis object.

Exemplarily, in response that the user clicks on the fourth control as shown in FIG. 9, the second analysis page as shown in FIG. 10 may be displayed in a form of a pop-up window. The associated object information of the first analysis object is displayed in the second analysis page, for example, an industry to which the associated object belongs, an object source, an object magnitude, etc.

Further, an operation control corresponding to the associated object information, such as a deletion control, is further displayed in the second analysis page, and the associated object information of the first analysis object may be deleted through the deletion control. One or more pieces of associated object information may be separately deleted, or the associated object information of the first analysis object may be deleted in batches.

Step d2: displaying, in a third analysis page, the at least one piece of associated object information in response to an interaction operation with the fifth control.

It may be understood that in response that the user needs to further analyze the associated object information or create the associated object information, the third analysis page is jumped to, and the associated object information is operated or the associated object information is created in the third analysis page.

It should be noted that in practical applications, the third analysis page may also be jumped to directly in response to the interaction operation with the fourth control, which may be adjusted according to the actual situation.

Step d3: displaying, in an object analysis area of the third analysis page, first associated object information and second associated object information in response to an add operation for the first associated object information in the at least one piece of associated object information, the second associated object information being obtained by performing fusion processing on the first associated object information in the object analysis area.

Specifically, a control for performing the add operation is displayed in a corresponding area of the associated object information, and the selected first associated object information may be added to the object analysis area through an interaction operation with the control. A fusion control of at least one fusion manner is displayed in the object analysis area, for example, a fusion control of “taking a union” and a fusion control of “taking an intersection”. The fusion manner of the first associated object information is determined through selection of the fusion control. Meanwhile, an add control is further displayed in the object analysis area, and interaction with the add control may be performed, and the first associated object information in the object analysis area is fused by using the selected fusion manner to obtain and display the second associated object information. For example, in response that the fusion control of “taking a union” is selected, the second associated object information is obtained based on the union of the first associated object information in the object analysis area.

Step d4: adding the second associated object information to the at least one piece of associated object information in response to an add operation for the second associated object information.

Specifically, a creation control is further displayed in a corresponding area of the second associated object information. In response to an interaction operation with the creation control, the second associated object information is added to the associated object information of the first analysis object.

According to the data analysis method provided in this embodiment, the fifth control for creating the associated object information of the first analysis object is provided, and the existing first associated object information is fused through the fifth control to obtain new second associated object information. Therefore, the efficiency of creating the associated object information may be effectively improved.

In some optional implementations, as shown in FIG. 11, a sixth control of at least one operation is further displayed in a corresponding area of the associated object information in the third analysis page. The data analysis method of the present disclosure further includes: performing, in response to an interaction operation with the sixth control, an operation corresponding to the sixth control on corresponding associated object information.

Specifically, the at least one operation includes at least one of an add operation, a delete operation, a push operation, a view operation, a report generation operation, an expand operation, and a recommendation operation. In addition, other operations may be set according to the actual situation, which is not limited here.

According to the data analysis method provided in this embodiment, the sixth control for operating the associated object information is provided. Therefore, the associated object information may be flexibly operated through the sixth control.

In some optional implementations, a seventh control of at least one analysis manner is displayed in a third display area of the first analysis page. The data analysis method of the present disclosure further includes:

Step e1: determining a target analysis manner in response to a selection operation for the seventh control.

Optionally, the target analysis manner includes at least one of a first analysis manner, a second analysis manner, and a third analysis manner, where the first analysis manner is used to analyze pre-search traffic, the second analysis manner is used to analyze a search term, and the third analysis manner is used to analyze a search result.

Step e2: displaying, in the third display area of the first analysis page, analysis data corresponding to the target analysis manner, the analysis data being related to the first search information.

Specifically, the corresponding search information in the first search information is analyzed by using the target analysis manner to obtain the analysis data corresponding to the target analysis manner.

According to the data analysis method provided in this embodiment, the seventh control of the at least one analysis manner is provided. Therefore, the analysis manner of the first search information may be switched through the seventh control to analyze the search condition represented by the first search information from multiple dimensions.

In some optional implementations, if the target analysis manner is the first analysis manner, step e2 includes: displaying, in the third display area of the first analysis page, media content of the first search source and first analysis data of the media content, the first analysis data being obtained by performing statistical analysis on first search data obtained after the media content is displayed, and the first search data being related to the first analysis object.

Specifically, the first search source corresponds to one or more pieces of media content, where the media content includes at least one of a video, a picture and text, and an audio. In addition, other media content may be selected according to the actual situation, which is not limited here.

Optionally, the first analysis data includes at least one of a publisher of the media content, a search term for the first analysis object search triggered by displaying the media content, a number of searches corresponding to the search term, and a total number of searches for the first analysis object, which may be adjusted according to an actual situation.

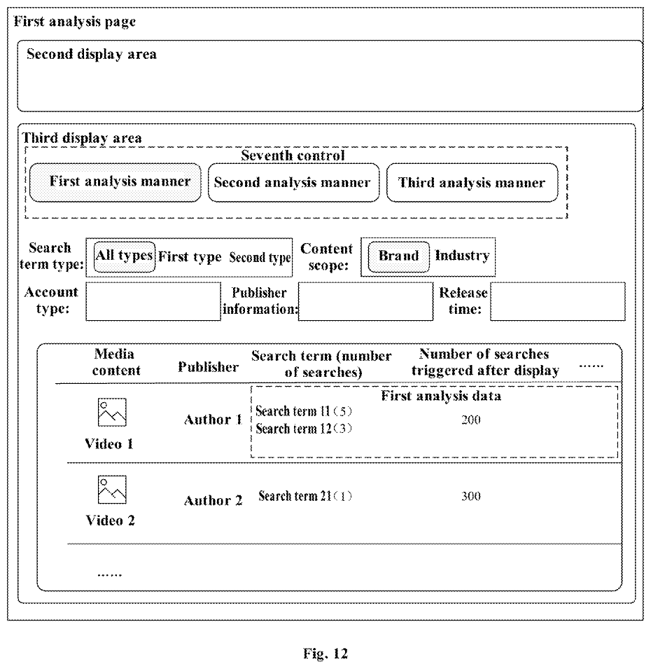

Further, as shown in FIG. 12, a configuration control of at least one first selection condition for the media content is further displayed in the third display area, and the at least one first selection condition includes a search term type, a content scope of the media content (such as a brand and an industry to which the first analysis object belongs, etc.), an account type of the publisher, information of the publisher, a release time, etc. The media content displayed in the third display area may be selected through configuration of the first selection condition.

Exemplarily, as shown in FIG. 12, if the first search source corresponds to video 1 and video 2, the first analysis data of video 1 is displayed in the third display area, for example, the publisher of video 1 is author 1, the search term (such as search term 11 and search term 12) for the first analysis object search triggered by displaying video 1, the number of searches (such as the number of searches of search term 11 is 5, and the number of searches of search term 12 is 2) corresponding to the search term, and the total number of searches (such as 200) for the first analysis object triggered after displaying video 1, etc.

According to the data analysis method provided in this embodiment, the media content of the first search source and the first analysis data of the media content are displayed through the selection of the first analysis manner. Therefore, the media content that triggers the search for the first analysis object or the associated content thereof may be analyzed by using the first analysis data of the media content, to search for the media content with a good recommendation effect, thereby optimizing the recommended media content and improving the search rate.

In some optional implementations, if the target analysis manner is the second analysis manner, step e2 includes: displaying, in the third display area of the first analysis page, a target search term used in the first search route and second analysis data of the target search term, the second analysis data being obtained by performing statistical analysis on second search data related to the target search term.

The second search data is related to the first analysis object and/or the associated content of the first analysis object.

Optionally, the second analysis data includes at least one of a number of searches for the first analysis object triggered by the target search term and a number of associated objects that initiate the search for the first analysis object through the target search term, which may be adjusted according to the actual situation.

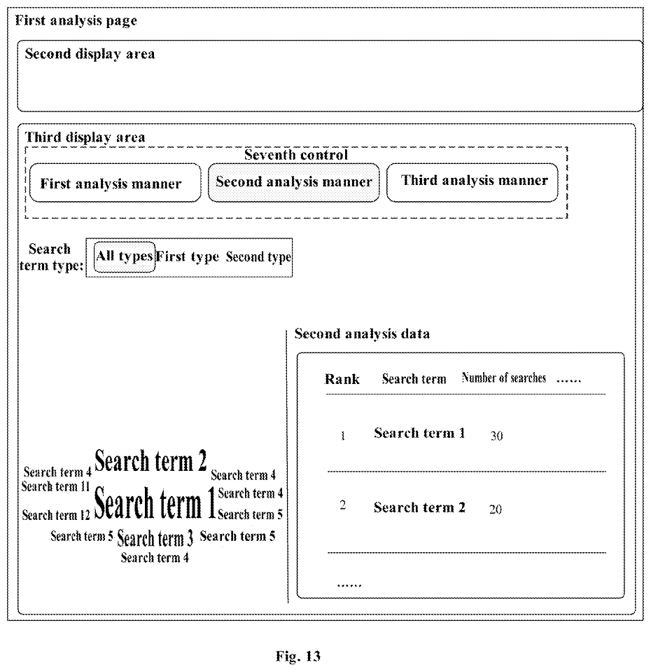

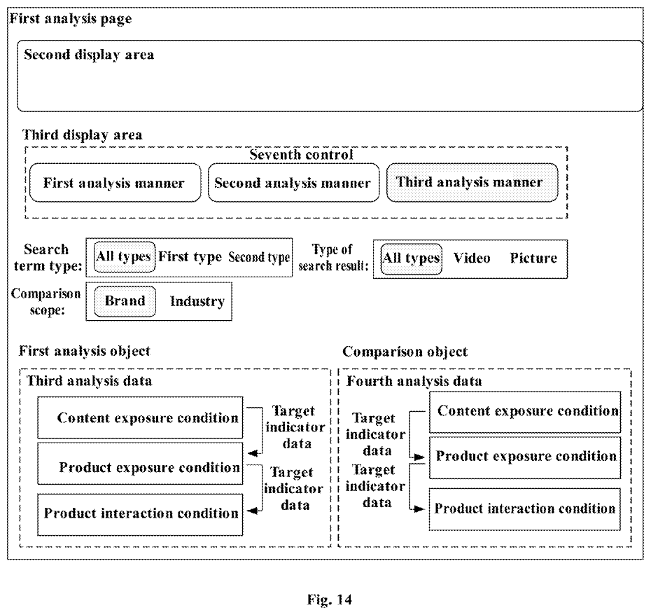

Further, as shown in FIG. 13, a configuration control of at least one second selection condition for the target search term is further displayed in the third display area, and the at least one second selection condition includes at least one of a search term type and a product that recommends using the target search term, which may be adjusted according to the actual situation.

Further, as shown in FIG. 13, a word cloud formed by the target search term is further displayed in the third display area.

Exemplarily, as shown in FIG. 13, if the target search terms such as search term 1, search term 2, and search term 3 are used in the first search route, the second analysis data of the target search terms such as search term 1, search term 2, and search term 3 is displayed in the third display area. For example, the number of searches for the first analysis object triggered by search term 1 is 30, and the number of searches for the first analysis object triggered by search term 2 is 20. Meanwhile, a word cloud composed of the target search terms may be displayed in the third display area according to the number of searches of the target search terms.

According to the data analysis method provided in this embodiment, the target search term used in the first search route and the second analysis data of the target search term are displayed through the selection of the second analysis manner. Therefore, the target search term that triggers the search for the first analysis object or the associated content thereof may be analyzed by using the second analysis data of the target search term, to search for the target search term that is frequently used in the search process, thereby optimizing the description term of the first analysis object or the associated content thereof and improving the search rate.

In some optional implementations, if the target analysis manner is the third analysis manner, step e2 includes: displaying, in the third display area of the first analysis page, third analysis data of the first search result, the third analysis data being obtained by performing statistical analysis on first operation data obtained after the first search result is displayed, and the first operation data being related to the associated content of the first analysis object.

Optionally, the third analysis data includes at least one of an exposure condition (such as a number of pieces of exposed content and a number of exposed products) of the associated content of the first analysis object and a product interaction condition triggered by the first search result, which may be adjusted according to the actual situation. The associated content includes content, a product, etc. of the first analysis object.

Further, the analysis data in the third analysis data has a hierarchical relationship, and target indicator data (such as a conversion rate) of the analysis data from an upper hierarchy to a current hierarchy in the third analysis data is further displayed in the third display area.

Further, as shown in FIG. 14, fourth analysis data of the comparison object of the first analysis object is further displayed in the third display area, and the fourth analysis data is obtained by performing statistical analysis on second operation data obtained after a search result of the comparison object is displayed.

Exemplarily, as shown in FIG. 14, the content exposure condition, the product exposure condition, and the product interaction condition (such as a product click condition and a product transaction condition) of the first search result may be displayed in the third display area, and the target indicator data from the content exposure condition to the product exposure condition and the target indicator data from the product exposure condition to the product interaction condition are displayed according to the hierarchical relationship among the content exposure condition, the product exposure condition, and the product interaction condition. The content exposure condition, the product exposure condition, and the product interaction condition (such as the product click condition and the product transaction condition) of the search result of the comparison object are displayed in the third display area, and the target indicator data from the content exposure condition to the product exposure condition and the target indicator data from the product exposure condition to the product interaction condition are displayed according to the hierarchical relationship among the content exposure condition, the product exposure condition, and the product interaction condition.

According to the data analysis method provided in this embodiment, the third analysis data of the first search result is displayed through the selection of the third analysis manner. Therefore, the associated content of the first analysis object may be optimized by searching for the search result with a good recommendation effect, thereby improving the search rate.

In some optional implementations, the data analysis method of the present disclosure further includes: acquiring first search data obtained after the media content of the first search source is displayed; performing statistical analysis based on the first search data to obtain first analysis data of the media content; interpreting the first analysis data to obtain a second analysis result; and displaying the second analysis result in the first display area.

Specifically, a second analysis template corresponding to the first analysis data may be pre-configured, and the first analysis data is interpreted through the second analysis template to obtain the second analysis result. Alternatively, the first analysis data is input into a pre-trained language model for interpretation to obtain the second analysis result. An interpretation manner of the first analysis data is not limited here, and may be selected according to an actual situation.

According to the data analysis method provided in this embodiment, the first analysis data corresponding to the media content of the first search source is interpreted to obtain and display the second analysis result. Therefore, the media content with a good recommendation effect for the first analysis object may be analyzed by using the second analysis result.

In some optional implementations, the data analysis method of the present disclosure further includes: acquiring second search data related to a target search term used in the first search route; performing statistical analysis on the second search data to obtain second analysis data of the target search term; interpreting the second analysis data to obtain a third analysis result; and displaying the third analysis result in the first display area.

Specifically, a third analysis template corresponding to the second analysis data may be pre-configured, and the second analysis data is interpreted through the third analysis template to obtain the third analysis result. Alternatively, the second analysis data is input into a pre-trained language model for interpretation to obtain the third analysis result. An interpretation manner of the second analysis data is not limited here, and may be selected according to the actual situation.

According to the data analysis method provided in this embodiment, the second analysis data corresponding to the target search term used in the first search route is interpreted to obtain and display the third analysis result. Therefore, the description term with a good search effect for the first analysis object may be analyzed by using the third analysis result.

In some optional implementations, the data analysis method of the present disclosure further includes: acquiring first operation data obtained after the first search result is displayed, the first operation data being related to the associated content of the first analysis object; performing statistical analysis based on the first operation data to obtain third analysis data of the first search result; determining a comparison object of the first analysis object, and acquiring second operation data obtained after a search result of the comparison object is displayed; performing statistical analysis based on the second operation data to obtain fourth analysis data; analyzing based on a comparison between the third analysis data and the fourth analysis data to obtain a fourth analysis result; and displaying the fourth analysis result in the first display area.

Specifically, a fourth analysis template corresponding to the third analysis data and the fourth analysis data may be pre-configured, and the third analysis data and the fourth analysis data are interpreted through the fourth analysis template to obtain the fourth analysis result. Alternatively, the third analysis data and the fourth analysis data are input into a pre-trained language model for interpretation to obtain the fourth analysis result. An interpretation manner of the third analysis data and the fourth analysis data is not limited here, and may be selected according to the actual situation.

According to the data analysis method provided in this embodiment, the third analysis data corresponding to the first search result and the fourth analysis data corresponding to the search result of the comparison object are interpreted. Therefore, the search result with a good recommendation effect for the first analysis object may be analyzed by using the fourth analysis result.

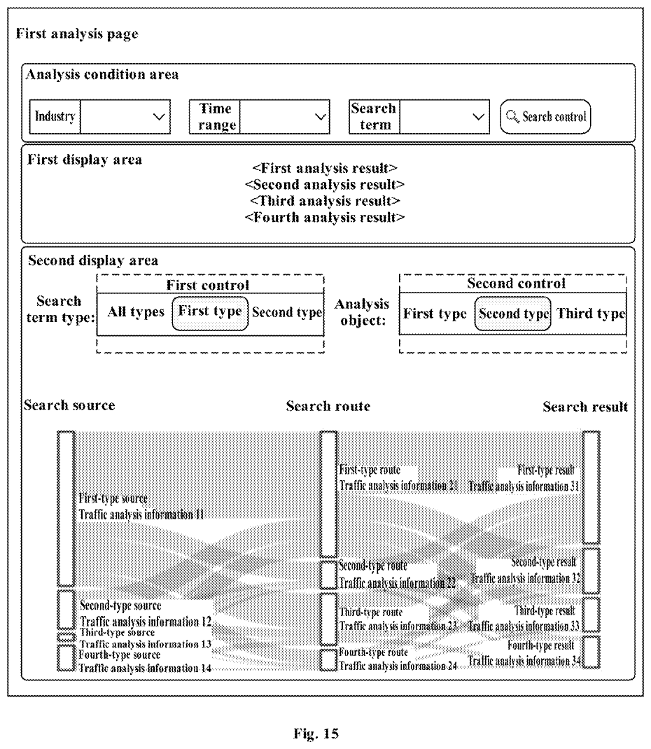

Exemplarily, as shown in FIG. 15, the first analysis result, the second analysis result, the third analysis result, and the fourth analysis result may be simultaneously displayed in the first display area in the first analysis page, so as to analyze the search condition of the first analysis object from multiple angles from the perspective of the traffic analysis information of the entire search path, the perspective of the media content before the search, the perspective of the search term used in the search, and the perspective of the undertaking result after the search, to provide diversified search data analysis.

As a specific application example, a client of a data platform is installed on the electronic device, and the client is configured to analyze the search condition of the analysis object by using the data analysis method of the present disclosure. The user may analyze the search condition of the analysis object from multiple dimensions through interaction operations with the page displayed by the client.

In this embodiment, a data analysis apparatus is further provided. The apparatus is configured to implement the foregoing embodiments and preferred implementations, which will not be repeated here. As used below, the term “module” may implement a combination of software and/or hardware for a predetermined function. Although the apparatus described in the following embodiments is preferably implemented in software, implementation in hardware, or a combination of software and hardware is also possible and contemplated.

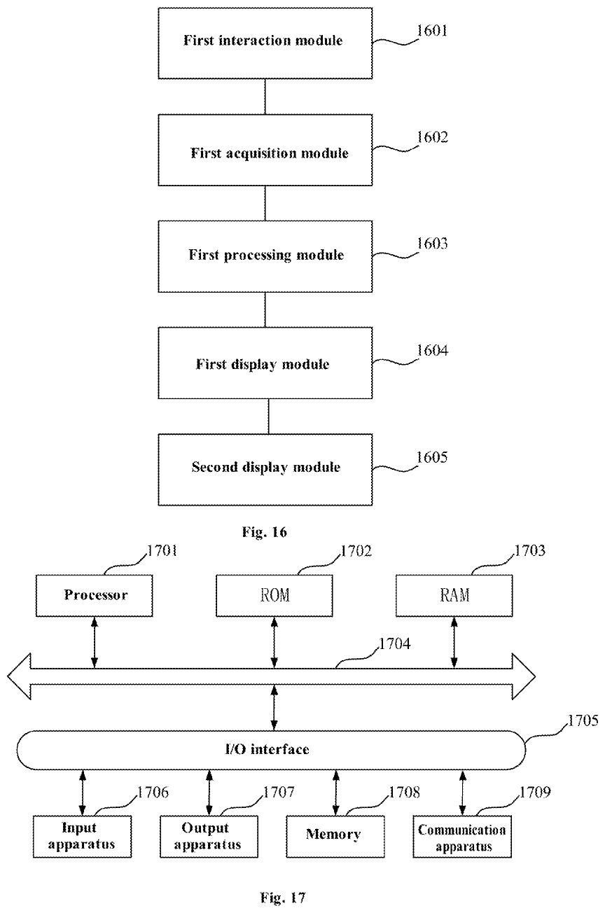

This embodiment provides a data analysis apparatus. As shown in FIG. 16, the apparatus includes:
a first interaction module 1601 configured to determine a target analysis condition and a first analysis object in response to an interaction operation for an analysis condition area in a first analysis page;
a first acquisition module 1602 configured to acquire first search information satisfying the target analysis condition and traffic analysis information of search information in the first search information, the first search information being related to the first analysis object, and the first search information including a first search source, a first search route, and a first search result;
a first processing module 1603 configured to analyze the first search information based on the traffic analysis information to obtain a first analysis result;
a first display module 1604 configured to display the first analysis result in a first display area of the first analysis page; and
a second display module 1605 configured to respectively display, in a second display area of the first analysis page, analysis nodes corresponding to the first search source, the first search route, and the first search result, and display a link relationship between the analysis nodes, the link relationship being used to represent a search path among the first search source, the first search route, and the first search result, and traffic analysis information of corresponding search information being displayed in corresponding areas of the analysis nodes.

In some optional implementations, the data analysis apparatus of the present disclosure further includes:
a second processing module configured to hide, in the first display area of the first analysis page, a link relationship not connected to a first analysis node in response to an interaction operation with the first analysis node in the first analysis page.

In some optional implementations, a first control is further displayed in the first analysis page, and the first control is used to switch a search term type. The data analysis apparatus of the present disclosure further includes:
a second interaction module configured to determine a target search term type in response to an interaction operation with the first control;
a second acquisition module configured to acquire second search information corresponding to the target search term type, the second search information being related to the first analysis object and satisfying the target analysis condition, and the second search information including a second search source, a second search route, and a second search result; and
a first update module configured to update, based on the second search information, the analysis nodes displayed in the first analysis page, the link relationship between the analysis nodes, and the traffic analysis information.

In some optional implementations, a second control is further displayed in the first analysis page, and the second control is used to switch the analysis object. The data analysis apparatus of the present disclosure further includes:
a third interaction module configured to determine a second analysis object in response to an interaction operation with the second control;
a third acquisition module configured to acquire third search information of the second analysis object, the third search information satisfying the target analysis condition, and the third search information including a third search source, a third search route, and a third search result; and
a second update module configured to update, based on the third search information, the analysis nodes displayed in the first analysis page, the link relationship between the analysis nodes, and the traffic analysis information.

In some optional implementations, the data analysis apparatus of the present disclosure further includes:
a fourth interaction module configured to display a third control corresponding to a second analysis node in response to an interaction operation with the second analysis node in the first analysis page, the third control being used to add associated object information of the first analysis object; and
a first add module configured to add, in response to an interaction operation with the third control, object information of an associated object generated by triggering search information corresponding to the second analysis node to the associated object information of the first analysis object.

In some optional implementations, a fourth control is further displayed in the first analysis page, and the fourth control is used to trigger display of at least one piece of associated object information of the first analysis object.

In some optional implementations, the data analysis apparatus of the present disclosure further includes:
a fifth interaction module configured to display, in a second analysis page, at least one piece of associated object information and a fifth control in response to an interaction operation with the fourth control, the fifth control being used to create associated object information of the first analysis object;
a sixth interaction module configured to display, in a third analysis page, the at least one piece of associated object information in response to an interaction operation with the fifth control;
a third processing module configured to display, in an object analysis area of the third analysis page, first associated object information and second associated object information in response to an add operation for the first associated object information in the at least one piece of associated object information, the second associated object information being obtained by performing fusion processing on the first associated object information in the object analysis area; and
a second add module configured to add the second associated object information to the at least one piece of associated object information in response to an add operation for the second associated object information.

In some optional implementations, a sixth control of at least one operation is further displayed in a corresponding area of the associated object information in the third analysis page. The data analysis apparatus of the present disclosure further includes:
a sixth interaction module configured to perform, in response to an interaction operation with the sixth control, an operation corresponding to the sixth control on corresponding associated object information.

In some optional implementations, a seventh control of at least one analysis manner is displayed in a third display area of the first analysis page. The data analysis apparatus of the present disclosure further includes:
a selection module configured to determine a target analysis manner in response to a selection operation for the seventh control; and
a third display module configured to display, in the third display area of the first analysis page, analysis data corresponding to the target analysis manner, the analysis data being related to the first search information.

In some optional implementations, the third display module includes:
a first display unit configured to: if the target analysis manner is a first analysis manner, display, in the third display area of the first analysis page, media content of the first search source and first analysis data of the media content, the first analysis data being obtained by performing statistical analysis on first search data obtained after the media content is displayed, and the first search data being related to the first analysis object.

In some optional implementations, the third display module further includes:
a second display unit configured to: if the target analysis manner is a second analysis manner, display, in the third display area of the first analysis page, a target search term used in the first search route and second analysis data of the target search term, the second analysis data being obtained by performing statistical analysis on second search data related to the target search term.

In some optional implementations, the third display module further includes:
a third display unit configured to: if the target analysis manner is the third analysis manner, display, in the third display area of the first analysis page, third analysis data of the first search result, the third analysis data being obtained by performing statistical analysis on first operation data obtained after the first search result is displayed, and the first operation data being related to the associated content of the first analysis object.

In some optional implementations, the data analysis apparatus of the present disclosure further includes:
a fourth acquisition module configured to acquire first search data obtained after the media content of the first search source is displayed;
a first analysis module configured to perform statistical analysis based on the first search data to obtain first analysis data of the media content;
a first interpretation module configured to interpret the first analysis data to obtain a second analysis result; and
a fourth display module configured to display the second analysis result in the first display area.

In some optional implementations, the data analysis apparatus of the present disclosure further includes:
a fifth acquisition module configured to acquire second search data related to a target search term used in the first search route;
a second analysis module configured to perform statistical analysis on the second search data to obtain second analysis data of the target search term;
a second interpretation module configured to interpret the second analysis data to obtain a third analysis result; and
a fifth display module configured to display the third analysis result in the first display area.

In some optional implementations, the data analysis apparatus of the present disclosure further includes:
a sixth acquisition module configured to acquire first operation data obtained after the first search result is displayed, the first operation data being related to the associated content of the first analysis object;
a third analysis module configured to perform statistical analysis based on the first operation data to obtain third analysis data of the first search result;
a fourth processing module configured to determine a comparison object of the first analysis object, and acquire second operation data obtained after a search result of the comparison object is displayed;
a fourth analysis module configured to perform statistical analysis based on the second operation data to obtain fourth analysis data;
a fifth analysis module configured to analyze based on a comparison between the third analysis data and the fourth analysis data to obtain a fourth analysis result; and
a sixth display module configured to display the fourth analysis result in the first display area.

The data analysis apparatus provided in the embodiments of the present disclosure may perform the data analysis method provided in any embodiment of the present disclosure, and has corresponding functional modules for performing the method and beneficial effects. On the one hand, the data analysis apparatus of the present disclosure analyzes the first search information based on the traffic analysis information corresponding to the search information in the first search information to obtain and display the first analysis result. Therefore, the key information in the first search information may be quickly learned through the first analysis result, so as to analyze the overall search condition of the first analysis object. On the other hand, the analysis nodes corresponding to the first search source, the first search route, and the first search result are displayed, and the link relationship between the analysis nodes is displayed. Therefore, the search path for the first analysis object may be restored, so as to analyze the main search source of the first analysis object in combination with the traffic analysis information of the first search source. Moreover, the main search route of the first analysis object is analyzed in combination with the traffic analysis information of the first search route. Moreover, the main undertaking result of the first analysis object is analyzed in combination with the traffic analysis information of the first search result. Furthermore, the search condition of the first analysis object is analyzed in multiple dimensions according to the first analysis result, the link relationship displayed in the second display area, and the traffic analysis information, so as to improve the accuracy of search analysis.

Further functional descriptions of the foregoing modules and units are the same as the corresponding embodiments above, and are not repeated here.

FIG. 17 is a structural block diagram of an electronic device according to an embodiment of the present disclosure.

Reference is made specifically to FIG. 17 below, which illustrates a structural block diagram of an electronic device suitable for implementing the embodiments of the present disclosure. The electronic device may include a processor (such as a central processing unit and a graphics processor) 1701, which may perform various appropriate actions and processes according to a program stored in a read-only memory (ROM) 1702 or a program loaded from a memory 1708 into a random access memory (RAM) 1703. Various programs and data required for operations of the electronic device are also stored in the RAM 1703. The processor 1701, the ROM 1702, and the RAM 1703 are connected to each other through a bus 1704. An input/output (I/O) interface 1705 is also connected to the bus 1704.

Usually, the following apparatuses may be connected to the I/O interface 1705: an input apparatus 1706 including, for example, a touch screen, a touchpad, a keyboard, a mouse, a camera, a microphone, an accelerometer, and a gyroscope; an output apparatus 1707 including, for example, a liquid crystal display (LCD), a speaker, and a vibrator; the memory 1708 including, for example, a magnetic tape and a hard disk; and a communication apparatus 1709. The communication apparatus 1709 may allow the electronic device to perform wireless or wired communication with other devices to exchange data. Although FIG. 17 shows the electronic device having various apparatuses, it should be understood that not all the apparatuses shown here need to be implemented or provided, and alternatively, more or fewer apparatuses may be implemented or provided.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, where the computer program includes program codes for performing the method shown in the flowchart. In such an embodiment, the computer program may be downloaded and installed from a network through the communication apparatus 1709, or installed from the memory 1708, or installed from the ROM 1702. When the computer program is executed by the processor 1701, the foregoing functions defined in the data analysis method of the embodiments of the present disclosure are executed.

The electronic device shown in FIG. 17 is only an example, and should not impose any limitation on the functions and the range of use of the embodiments of the present disclosure.

The embodiments of the present disclosure further provide a computer-readable storage medium. The method according to the embodiments of the present disclosure may be implemented in hardware and firmware, or implemented as computer codes that may be recorded in a storage medium or originally stored in a remote storage medium or a non-transitory machine-readable storage medium and downloaded through a network and will be stored in a local storage medium, so that the method described here may be stored on such software on the storage medium using a general-purpose computer, a special-purpose processor, or programmable or special-purpose hardware. The storage medium may be a magnetic disk, an optical disk, a read-only memory, a random access memory, a flash memory, a hard disk, or a solid-state disk. Further, the storage medium may further include a combination of the foregoing types of memories. It should be understood that the computer, the processor, the microprocessor controller, or the programmable hardware includes a storage component that may store or receive software or computer codes, and when the software or the computer codes are accessed and executed by the computer, the processor, or the hardware, the data analysis method shown in the foregoing embodiments is implemented.

A part of the present disclosure may be applied as a computer program product, such as computer program instructions, which, when executed by a computer, may invoke or provide the method and/or the technical solutions according to the present disclosure through operations of the computer. Those skilled in the art should understand that the computer program instructions exist in a computer-readable medium in forms including, but not limited to, a source file, an executable file, an installation package file, etc. Accordingly, the computer program instructions are executed by the computer in manners including, but not limited to: the computer directly executes the instructions, or the computer compiles the instructions and then executes the corresponding compiled program, or the computer reads and executes the instructions, or the computer reads and installs the instructions and then executes the corresponding installed program. Here, the computer-readable medium may be any available computer-readable storage medium or communication medium accessible by the computer.

Although the embodiments of the present disclosure are described here with reference to the drawings, those skilled in the art may make various modifications and variations without departing from the spirit and scope of the present disclosure, and such modifications and variations fall within the scope defined by the appended claims.

1. A data analysis method, comprising:
determining a first analysis condition and a first analysis object in response to an interaction operation for an analysis condition area in a first analysis page;
acquiring first search information satisfying the first analysis condition, and traffic analysis information of search information in the first search information, the first search information being related to the first analysis object, and the first search information comprising a first search source, a first search route, and a first search result;
analyzing the first search information based on the traffic analysis information to obtain a first analysis result;
displaying the first analysis result in a first display area of the first analysis page; and
respectively displaying, in a second display area of the first analysis page, analysis nodes corresponding to the first search source, the first search route, and the first search result, and displaying a link relationship between the analysis nodes, the link relationship being used to represent a search path among the first search source, the first search route, and the first search result, and traffic analysis information of corresponding search information being displayed in corresponding areas of the analysis nodes.

2. The method of claim 1, wherein the method further comprises:
hiding, in the first display area of the first analysis page, a link relationship not connected to a first analysis node in response to an interaction operation with the first analysis node in the first analysis page.

3. The method of claim 1, wherein a first control is further displayed in the first analysis page, and the first control is used to switch a search term type; and the method further comprises:
determining a first search term type in response to an interaction operation with the first control;
acquiring second search information corresponding to the first search term type, the second search information being related to the first analysis object and satisfying the first analysis condition, and the second search information comprising a second search source, a second search route, and a second search result; and
updating, based on the second search information, the analysis nodes displayed in the first analysis page, the link relationship between the analysis nodes, and the traffic analysis information.

4. The method of claim 1, wherein a second control is further displayed in the first analysis page, and the second control is used to switch an analysis object; and the method further comprises:
determining a second analysis object in response to an interaction operation with the second control;
acquiring third search information of the second analysis object, the third search information satisfying the first analysis condition, and the third search information comprising a third search source, a third search route, and a third search result; and
updating, based on the third search information, the analysis nodes displayed in the first analysis page, the link relationship between the analysis nodes, and the traffic analysis information.

5. The method of claim 1, wherein the method further comprises:
displaying a third control corresponding to a second analysis node in response to an interaction operation with the second analysis node in the first analysis page, the third control being used to add associated object information of the first analysis object; and
adding, in response to an interaction operation with the third control, object information of an associated object generated by triggering search information corresponding to the second analysis node to the associated object information of the first analysis object.

6. The method of claim 1, wherein a fourth control is further displayed in the first analysis page, and the fourth control is used to trigger display of at least one piece of associated object information of the first analysis object.

7. The method of claim 6, wherein the method further comprises:
displaying, in a second analysis page, the at least one piece of associated object information and a fifth control in response to an interaction operation with the fourth control, the fifth control being used to create associated object information of the first analysis object;
displaying, in a third analysis page, the at least one piece of associated object information in response to an interaction operation with the fifth control;
displaying, in an object analysis area of the third analysis page, first associated object information and second associated object information in response to an add operation for the first associated object information in the at least one piece of associated object information, the second associated object information being obtained by performing fusion processing on the first associated object information in the object analysis area; and
adding the second associated object information to the at least one piece of associated object information in response to an add operation for the second associated object information.

8. The method of claim 7, wherein a sixth control of at least one operation is further displayed in a corresponding area of the associated object information in the third analysis page; and the method further comprises:
performing, in response to an interaction operation with the sixth control, an operation corresponding to the sixth control on corresponding associated object information.

9. The method of claim 1, wherein a seventh control of at least one analysis manner is displayed in a third display area of the first analysis page; and the method further comprises:
determining a first analysis manner in response to a selection operation on the seventh control; and
displaying, in the third display area of the first analysis page, analysis data corresponding to the first analysis manner, the analysis data being related to the first search information.

10. The method of claim 9, wherein in response to the first analysis manner being a first analysis manner, the displaying, in the third display area of the first analysis page, the analysis data corresponding to the first analysis manner comprises:
displaying, in the third display area of the first analysis page, media content of the first search source and first analysis data of the media content, the first analysis data being obtained by performing statistical analysis on first search data obtained after the media content is displayed, and the first search data being related to the first analysis object.

11. The method of claim 9, wherein in response to the first analysis manner being a second analysis manner, the displaying, in the third display area of the first analysis page, the analysis data corresponding to the first analysis manner comprises:
displaying, in the third display area of the first analysis page, a first search term used in the first search route and second analysis data of the first search term, the second analysis data being obtained by performing statistical analysis on second search data related to the first search term.

12. The method of claim 9, wherein in response to the first analysis manner being a third analysis manner, the displaying, in the third display area of the first analysis page, the analysis data corresponding to the first analysis manner comprises:
displaying, in the third display area of the first analysis page, third analysis data of the first search result, the third analysis data being obtained by performing statistical analysis on first operation data obtained after the first search result is displayed, and the first operation data being related to associated content of the first analysis object.

13. The method of claim 1, wherein the method further comprises:
acquiring first search data obtained after media content of the first search source is displayed;
performing statistical analysis based on the first search data to obtain first analysis data of the media content;
interpreting the first analysis data to obtain a second analysis result; and
displaying the second analysis result in the first display area.

14. The method of claim 1, wherein the method further comprises:
acquiring second search data related to a first search term used in the first search route;
performing statistical analysis on the second search data to obtain second analysis data of the first search term;
interpreting the second analysis data to obtain a third analysis result; and
displaying the third analysis result in the first display area.

15. The method of claim 1, wherein the method further comprises:
acquiring first operation data obtained after the first search result is displayed, the first operation data being related to associated content of the first analysis object;
performing statistical analysis based on the first operation data to obtain third analysis data of the first search result;
determining a comparison object of the first analysis object, and acquiring second operation data obtained after a search result of the comparison object is displayed;
performing statistical analysis based on the second operation data to obtain fourth analysis data;
analyzing based on a comparison between the third analysis data and the fourth analysis data to obtain a fourth analysis result; and
displaying the fourth analysis result in the first display area.

16. An electronic device, comprising:
at least one memory and at least one processor, the at least one memory and the at least one processor being communicatively connected to each other, the at least one memory storing computer instructions, and the at least one processor executing the computer instructions to perform a data analysis method, comprising:
determining a first analysis condition and a first analysis object in response to an interaction operation for an analysis condition area in a first analysis page;
acquiring first search information satisfying the first analysis condition, and traffic analysis information of search information in the first search information, the first search information being related to the first analysis object, and the first search information comprising a first search source, a first search route, and a first search result;
analyzing the first search information based on the traffic analysis information to obtain a first analysis result;
displaying the first analysis result in a first display area of the first analysis page; and
respectively displaying, in a second display area of the first analysis page, analysis nodes corresponding to the first search source, the first search route, and the first search result, and displaying a link relationship between the analysis nodes, the link relationship being used to represent a search path among the first search source, the first search route, and the first search result, and traffic analysis information of corresponding search information being displayed in corresponding areas of the analysis nodes.

17. The device of claim 16, wherein the method further comprises:
hiding, in the first display area of the first analysis page, a link relationship not connected to a first analysis node in response to an interaction operation with the first analysis node in the first analysis page.

18. The device of claim 16, wherein a first control is further displayed in the first analysis page, and the first control is used to switch a search term type; and the method further comprises:
determining a first search term type in response to an interaction operation with the first control;
acquiring second search information corresponding to the first search term type, the second search information being related to the first analysis object and satisfying the first analysis condition, and the second search information comprising a second search source, a second search route, and a second search result; and
updating, based on the second search information, the analysis nodes displayed in the first analysis page, the link relationship between the analysis nodes, and the traffic analysis information.

19. A non-transitory computer-readable storage medium having computer instructions stored thereon, wherein the computer instructions are used to cause a computer to perform a data analysis method, comprising:
determining a first analysis condition and a first analysis object in response to an interaction operation for an analysis condition area in a first analysis page;
acquiring first search information satisfying the first analysis condition, and traffic analysis information of search information in the first search information, the first search information being related to the first analysis object, and the first search information comprising a first search source, a first search route, and a first search result;
analyzing the first search information based on the traffic analysis information to obtain a first analysis result;
displaying the first analysis result in a first display area of the first analysis page; and
respectively displaying, in a second display area of the first analysis page, analysis nodes corresponding to the first search source, the first search route, and the first search result, and displaying a link relationship between the analysis nodes, the link relationship being used to represent a search path among the first search source, the first search route, and the first search result, and traffic analysis information of corresponding search information being displayed in corresponding areas of the analysis nodes.

20. The non-transitory computer-readable storage medium of claim 19, wherein the method further comprises:
hiding, in the first display area of the first analysis page, a link relationship not connected to a first analysis node in response to an interaction operation with the first analysis node in the first analysis page.
